(19) United States
(12) Patent Application Publication
(10) Pub. No.: US 2016/0012137 A1
(43) Pub. Date: Jan. 14, 2016

(54) AUTOMATED COMPOSITION OF GEOGRAPHICALLY RELEVANT MEDIA

(71) Applicant: International Business Machines Corporation, Armonk, NY (US)

(72) Inventors: Gary D. Cudak, Creedmoor, NC (US); Christopher J. Hardee, Raleigh, NC (US); Sarbajit K. Rakshit, Kolkata (IN)

(21) Appl. No.: 14/841,684

(22) Filed: Aug. 31, 2015

Related U.S. Application Data
(63) Continuation of application No. 14/326,453, filed on Jul. 8, 2014.

(51) Int. Cl. G06F 17/30

(52) U.S. Cl. CPC G06F 17/30867; G06F 17/30241; G06F 17/30554

(57) ABSTRACT

Embodiments of the present invention provide a method, system and computer program product for the automated composition of geographically relevant media. In an embodiment of the invention, a method for automated composition of geographically relevant media includes receiving a topical query through a search user interface communicatively coupled to a search engine over a data communications network and identifying a particular geographical region of interest within the topical query. The method also includes retrieving a result set of individual media content from the search engine and extracting from the result set only individual media content pertinent to the particular geographical region of interest. Finally, the method includes combining the extracted individual media content in a composite media file and returning the composite media file in the search user interface.

### BACKGROUND OF THE INVENTION

1. Field of the Invention

The present invention relates to the composition of media from multiple different media sources.

2. Description of the Related Art

The advent of the Internet has produced enumerable ways for individuals to seek out and acquire information about virtually anything. Initially, when the Internet primarily served as medium over which academics shared publications and individuals exchanged messages, the development of the World Wide Web resulted in new modes of sharing not just documents, but also other types of media including imagery, audio, and video. Most recently, the maturation of social media has facilitated even more advanced modes of publishing media, and consuming media.

Accessing media files generally requires one to indicate through a search engine, media pertinent to a particular topic. The result set, however, can include a vast selection of links to media of irrelevance to the desired topic. Consequently, the end user is compelled to expend great efforts in seeking out topically relevant media. The use of media specific search engines and repositories can alleviate some of the inconvenience in locating topical media of interest in that at least the result set of a search is limited to a particular type of media—namely video material.

Oftentimes, media pertaining to a particular topic can include several subtopical elements—but not all subtopical elements associated with a desired topic. As a result, one seeking full media coverage of a particular topic is required to locate multiple different topically relevant media files in order to achieve complete coverage of the topic. In doing so, of course, much retrieved material is redundantly present in the different media files. Accordingly, much time is wasted reviewing video material of common subtopics only to access video material containing complete coverage of the topic inclusive of all subtopics.

One relevant topical notion is that of geography. The advent of mobile computing has rendered the notion of geography an important notion—particularly in respect to the retrieval of content on a mobile device. In this regard, frequently the most relevant result set of a media query by a mobile device is a result set of geographically relevant material with respect to a contemporaneous location of the mobile device. Yet, as in the case of other types of media, on many occasions the geographically relevant portion of media is embedded deep within media otherwise not necessarily geographically relevant.

### BRIEF SUMMARY OF THE INVENTION

Embodiments of the present invention address deficiencies of the art in respect to media retrieval and provide a novel and non-obvious method, system and computer program product for the automated composition of geographically relevant media. In an embodiment of the invention, a method for automated composition of geographically relevant media includes receiving a topical query through a search user interface communicatively coupled to a search engine over a data communications network and identifying a particular geographical region of interest within the topical query. The method also includes retrieving a result set of individual media content from the search engine and extracting from the result set only individual media content pertinent to the particular geographical region of interest. Finally, the method includes combining the extracted individual media content in a composite media file and returning the composite media file in the search user interface.

In one aspect of the embodiment, the individual media content are video files. In another aspect of the embodiment, the particular geographical region of interest is specified in the search user interface graphically by selecting with a pointing device a portion of an image of a geographical area. In yet another aspect of the embodiment, only geographically pertinent portions of the individual media content are extracted from the individual media content and combined in the composite media file while other portions of the individual media content are excluded from addition to the composite media file.

In another embodiment of the invention, a media retrieval data processing system is configured for automated composition of geographically relevant media. The system includes a host computing system that has one or more computers each with memory and at least one processor. The system also includes a search engine executing in the memory of the host computing system and responding to topical search queries by retrieving from over a data communications network individual media content according to the topical search queries. Finally, the system includes an automated composition module coupled to the search engine and executing in the memory of the host computing system. The module includes program code enabled to identify a particular geographical region of interest within a topical query received in the search engine, to extract from a result set of individual media content, only individual media content pertinent to the particular geographical region of interest, to combine the extracted individual media content in a composite media file and to return the composite media file to a search user interface accessing the search engine and issuing the topical query.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for the automated composition of geographically relevant media;

FIG. 2 is a schematic illustration of a media retrieval data processing system configured for the automated composition of geographically relevant media; and,

FIG. 3 is a flow chart illustrating a process for the automated composition of geographically relevant media.

### DETAILED DESCRIPTION OF THE INVENTION

Embodiments of the invention provide for the automated composition of geographically relevant media. In accordance with an embodiment of the invention, a result set of one or more media files are retrieved in response to a query by an end user, and a specified geographical area can be compared to the media file or files of the result set. Relevant portions of the media file or files corresponding to the specified geographical area thereafter can be identified and composited into geographically relevant media. As such, the composition can be returned to the end user as the geographically relevant portion of the media file or files of the result set.

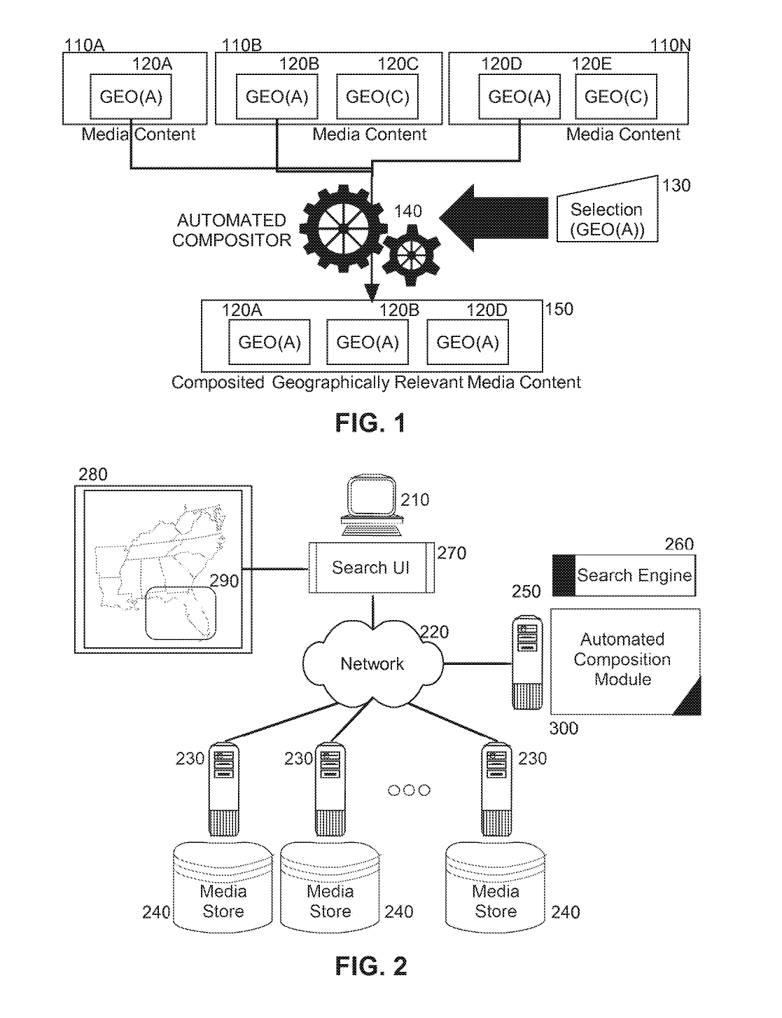

In further illustration, FIG. 1 pictorially shows a process for the automated composition of geographically relevant media. As shown in FIG. 1, media content 110A, 110B, 110N can include different geographically relevant portions 120A, 120B, 120C, 120D, 120E. The geographically relevant portions 120A, 120B, 120C, 120D, 120E can include content pertaining to a particular geographic region whether that region be a nationally defined jurisdiction such as a country, a naturally defined geographic area or feature such as a continent, river, mountain or valley, an artificially defined geographic area such as a neighborhood, building or park, a politically defined area such as a state or province, county, municipality, or any portion of a defined geographic thereof.

An automated compositor 140 can receive a search request 130 for content of a particular geographic relevance. In response, the automated compositor 140 can retrieve the media content 110A, 110B, 110N. The automated compositor 140 can determined which of the media content 110A, 110B, 110N pertains to the particular geographic relevance combine geographically relevant portions 120A, 120B, 120D of the media content 110A, 110B, 110N for aggregation within composited media content 150. In this regard, for the retrieved media content 110A, 110B, 110N, it can be determined that the entirety of one or more of the individual media content 110A, 110B, 110N is geographically relevant. Or, one or more portions of the individual media content 110A, 110B, 110N can be determined to be geographically relevant.

The process described in connection with FIG. 1 can be implemented within a media retrieval data processing system. In further illustration, FIG. 2 schematically shows a media retrieval data processing system configured for the automated composition of geographically relevant media. The system can include a host computing system 250 that includes one or more computers each with memory and at least one processor. The host computing system 250 can be coupled over data communications network 220 to one or more content servers 230 each with its own data store 240 of media content. The host computing system 250 can support the operation of a search engine 260 processing search requests for media content of a specific geographically relevant nature.

In this regard, the search engine 260 can receive the search requests from over the data communications network 220 from a search user interface 270 displayed in a client computing device 210. The search requests can be provided manually in a textual input field of a form present in the search user interface 270. Alternatively, the search requests can be provided graphically through the manipulation of a pointing device graphically specifying on an image 280 a specific geographical region 290 as shown in FIG. 2. In any event, the search requests can be processed through the search engine 260 by way of an automated composition module 300.

The automated composition module 300 can include program code that when executed in the memory of the host computing system 250 is enabled to identify within a set of retrieved media content retrieved by the search engine 260 only media content pertinent to a specified geographically region. In one aspect of the embodiment, the program code of the automated composition module 300 is enabled to identify within individually retrieved media content, discrete portions of the individually retrieved media content pertinent to the specified geographical region to the extent that only discrete potions of the individually retrieved media content pertain to the specified geographical region while other portions of the individually retrieved media content pertain to other geographical regions or no geographical regions in particular.

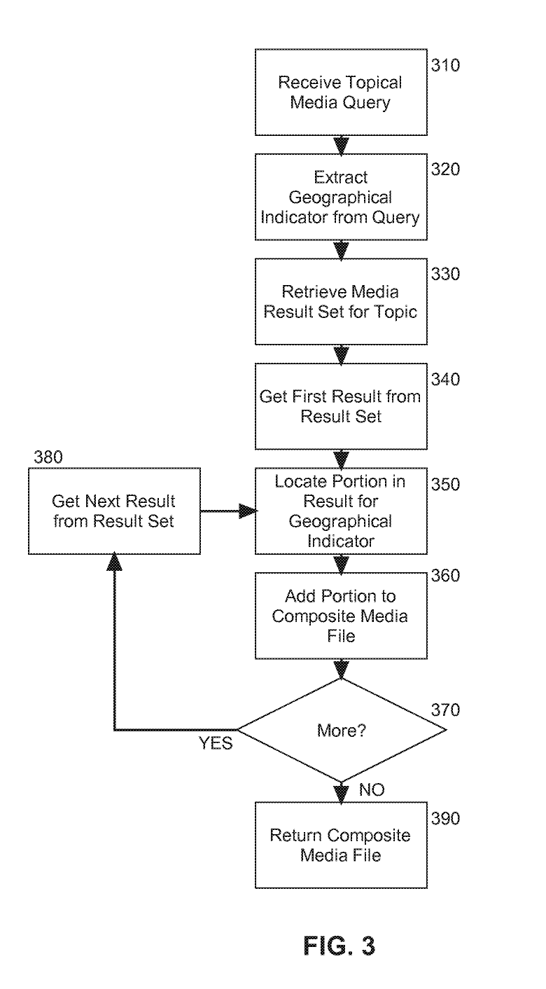

In even yet further illustration of the operation of the automated composition module 300, FIG. 3 is a flow chart illustrating a process for the automated composition of geographically relevant media. Beginning in block 310, a topical media query can be received from a requestor through a search engine user interface specifying a particular geographical area of interest. In block 320, a geographical indicator of the particular geographical area can be extracted from the topical media query and in block 330, a result set of individual media content can be retrieved for the topical media query irrespective of the particular geographical area of interest. In block 340, a first individual media content result can be selected from the result set and in block 350, any portion of the selected media content corresponding to the particular geographical area can be located and added to a composite media file in block 360.

In decision block 370, if additional individual media content results remain to be processed in the result set, in block 380 a next individual media content result in the result set can be selected for processing and, once again, in block 350, any portion of the selected media content corresponding to the particular geographical area can be located and added to a composite media file in block 360. In decision block 370, when no additional individual media content results remain to be processed, in block 390 the composite media file can be returned to the search engine user interface as a composition of only those portions of the individual media content of the result set that are pertinent to the particular geographical area of interest.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for automated composition of geographically relevant media, the method comprising:
receiving a topical query through a search user interface communicatively coupled to a search engine over a data communications network;
identifying a particular geographical region of interest within the topical query;
retrieving a result set of individual media content from the search engine;
extracting from the result set only individual media content pertinent to the particular geographical region of interest;
combining the extracted individual media content in a composite media file; and,
returning the composite media file in the search user interface.

2. The method of claim 1, wherein the individual media content are video files.

3. The method of claim 1, wherein the particular geographical region of interest is specified in the search user interface graphically by selecting with a pointing device a portion of an image of a geographical area.

4. The method of claim 1, wherein only geographically pertinent portions of the individual media content are extracted from the individual media content and combined in the composite media file while other portions of the individual media content are excluded from addition to the composite media file.
